(19) United States
(12) Patent Application Publication
(10) Pub. No.: US 2006/0248551 A1
(43) Pub. Date: Nov. 2, 2006

(54) Single motor connected to an optical pick up unit and an optical print head

(76) Inventors: Lawrence N. Taugher, Loveland, CO (US); Darwin Mitchel Hanks, Fort Collins, CO (US); Paul W. Martin, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/116,846

(22) Filed: Apr. 28, 2005

(51) Int. Cl. G11B 7/09; G11B 7/08; G11B 7/085; G11B 7/00

(52) U.S. Cl. 720/659

(57) ABSTRACT

This invention relates to an optical disk writing and printing apparatus comprising; a motor operatively connected to an optical pickup unit and an optical print head such that the motor is engagingly connected to the optical pickup unit for assisting the optical pickup unit in writing data on one side of an optical disk and engagingly connected to the optical print head for assisting the optical print head in printing markings on another side of the optical disk.

### BACKGROUND OF THE INVENTION

1. Field of the Invention

This invention relates to an optical disk writing and printing apparatus comprising; a motor operatively connected to an optical pickup unit and an optical print head such that the motor is engagingly connected to the optical pickup unit for assisting the optical pickup unit in writing data on one side of an optical disk and engagingly connected to the optical print head for assisting the optical print head in printing markings on another side of the optical disk.

2. Description of the Related Art

Optical disks represent a significant percentage of the market for data storage of software as well as of photographic, video, and/or audio data. Typically, optical disks have data patterns embedded thereon that can be read from and/or written to one side of the disk, and a graphic display/mark or label printed on the other side of the disk. Prior to the present invention, as set forth in general terms above and more specifically below, it is known, in the optical disk media art to employ a spindle motor that is used to write data upon one side of the optical disk. However, in order to print graphics or other suitable markings upon the other side of the optical disk, a separate printing station utilizing another spindle motor must be employed. Various optical disk formats include, but are not limited to, CD, CD-ROM, CD-R, CD-RW, DVD, DVD-R, and DVD-RW. Consequently, a more advantageous system, then, would be provided if a single spindle motor could be utilized that is connected to both the optical pickup unit (OPU) for writing data upon one side of the optical disk and the optical print head (OPH) for printing graphics or other suitable markings upon the other side of optical disk.

It is apparent from the above that there exists a need in the optical disk writing and printing art for a single spindle motor that is connected to both the optical pickup unit (OPU) for writing data upon one side of the optical disk and the optical print head (OPH) for printing graphics or other suitable markings upon the other side of optical disk. It is a purpose of this invention to fulfill this and other needs in the art in a manner more apparent to the skilled artisan once given the following disclosure.

### SUMMARY OF THE INVENTION

Generally speaking, an embodiment of this invention fulfills these needs by providing an optical disk writing and printing apparatus comprising; a motor operatively connected to an optical pickup unit and an optical print head such that the motor is engagingly connected to the optical pickup unit for assisting the optical pickup unit in writing data on one side of an optical disk and engagingly connected to the optical print head for assisting the optical print head in printing markings on another side of the optical disk.

In certain preferred embodiments, the optical print head is disengaged from the apparatus when the optical pickup unit is writing data upon the optical disk. The optical print head is then engaged to the apparatus when it is desired to print markings upon the other side of the optical disk.

In another further preferred embodiment, a single spindle motor is utilized that is capable of being connected to both the optical pickup unit (OPU) for writing data upon one side of the optical disk and the optical print head (OPH) for printing graphics or other suitable markings upon the other side of optical disk.

The preferred optical media writing and printing apparatus, according to various embodiment of the present invention, offers the following advantages: ease of data writing; ease of marking printing; improved economy; reduced part count; and increased writing/printing efficiency. In fact, in many of the preferred embodiments, these factors of improved economy, reduced part count, and increased writing/printing efficiency are optimized to an extent that is considerably higher than heretofore achieved in prior, known optical media writing and printing apparatus.

The above and other features of the present invention, which will become more apparent as the description proceeds, are best understood by considering the following detailed description in conjunction with the accompanying drawings, wherein like characters represent like parts throughout the several views and in which:

### BRIEF DESCRIPTION OF THE DRAWINGS

FIG. 1 is a schematic illustration of an optical media writing and printing apparatus wherein the optical pickup unit is being utilized, according to one embodiment of the present invention;

FIG. 2 is a schematic illustration of the optical media writing and printing apparatus wherein the optical print head is being utilized, according to another embodiment of the present invention;

FIG. 3 is a schematic illustration of the optical media writing and printing apparatus wherein the optical print head is traversed along the media in order to print marks upon the media, according to another embodiment of the present invention; and

FIG. 4 is a schematic illustration of the optical media writing and printing apparatus wherein the optical print head unit has completed placing marks upon the media, according to another embodiment of the present invention.

### DETAILED DESCRIPTION OF THE INVENTION

In describing and claiming the present invention, the following terminology will be used.

As used herein, “media” is meant to encompass any coatable surface, composed of wood, plastic, clay, paper, polymers, metals etc. One example is audio, video, multimedia, and/or software disks that are machine readable in a CD and/or DVD drive, or the like. Examples of optical disk formats include writable, recordable, and rewritable disks.

As used herein, “mark” can include any visible character or image found on a media or any surface used for viewing and conveying information. For example, the mark is found prominently on one side of the optical disk, but this is not always the case.

As used herein, “data” is typically used to include the non-graphic information contained on the optical disk that is digitally or otherwise embedded therein. Data can include audio information, video information, photographic information, software information, or the like.

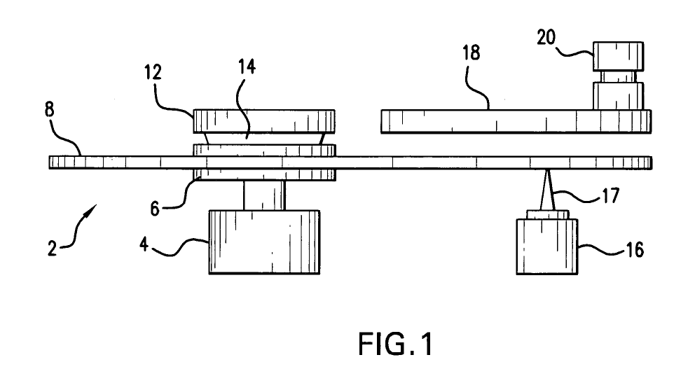

FIG. 1 shows an optical-mechanical system 2, according to an embodiment of the invention. System 2 is used for writing data (not shown) upon one side of media 8 and printing marks (not shown) upon the other side of media 8. Preferably, system 2 includes, in part, spindle motor 4, media clamp 6, media 8, media gear 12, media hub 14, conventional optical pickup unit (OPU) 16 which emits conventional laser beam 17, optical print head (OPH) gear 18, and optical print head (OPH) 20.

In order to write data upon media 8, OPU 16 outputs laser light 17. Typically, the laser is a 400 to 800 nm laser operated over a power range of 0.01 to 100 mW. Preferably, the laser is operated over a power range of 1-5 mW for read operations and 25-60 mW for write operations. As is well-known in the optical disk media art, as spindle motor 4 rotates OPU 16 and laser beam 17 are radially tracked along one side of media 8 in order to write data upon that side of media 8.

As can be further seen in FIG. 1, media 8 is attached to spindle motor 4 by media clamp 6 and to hub 14. Hub 14 is conventionally connected to media gear 12. Finally, optical print head gear 18 has been conventionally disengaged from (does not contact) media gear 12. In this manner, as spindle motor 4 rotates to allow optical pickup unit 16 to write data upon one side of media 8, optical print head gear 18 and optical print head 20 remain stationary. Due to the fact that optical print head 20 is not engaged to media gear 12, this allows the data to be written upon media 8 at its optimum speed. This is because the weight of optical print head 20 is not engaged with spindle motor 4 so that spindle motor 4 only interacts with optical pickup unit 16 and media 8 in this data write mode.

With respect to the engagement/disengagement of optical print head gear 18 from media gear 12, it is well-known that a variety of suitable techniques and mechanisms can be utilized in order to disengage media gear 12 from optical print head gear 18 and engage media gear 12 with optical print head gear 18. It is to be understood that gears 12 and 18 could be permanently engaged.

Changes to the apparatus 2 can also be made without departing from the spirit or scope of the invention. For instance, in one embodiment, apparatus 2 can be rotated 180° such that optical pickup unit 16 can be located above media 8 and optical print head 20 can be located below media 8.

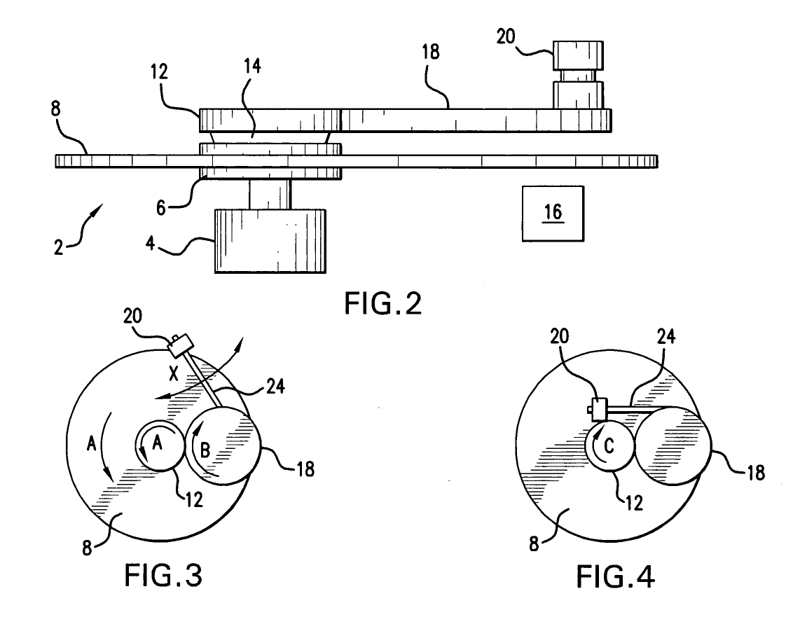

With respect to FIG. 2, apparatus 2 is illustrated. As shown in FIG. 2, optical print head gear 18 is engaged with media gear 12. In this manner, optical print head 20 can be used to place marks upon media 8. It is to be understood that if optical print head 20 is being utilized to place marks upon media 8, optical pickup unit 16 is not operated.

As shown in FIG. 3, when media 8 and media gear 12 are rotated in the direction of Arrows A, this causes optical print head gear 18 to rotate in the direction of Arrow B. Optical print head 20 is conventionally attached to optical print head arm 24. Optical print head arm 24 is also rotatably connected to optical print head gear 18. In this manner, as optical print head gear 18 rotates in the direction of Arrow B, optical print head gear 18 interacts with optical print head arm 24 and optical print head 20 to allow optical print head 20 to gradually traverse along media 8 in one direction of Arrow X (from the OD of media 8 towards the ID of media 8) so that optical print head 20 can print marks upon media 8. For example, one full rotation of gear 12 causes a very small partial rotation of gear 18 so that the OPH moves exactly one track inward.

As shown in FIG. 4, optical print head 20 has completed the placing of marks on media 8 and is located adjacent to media gear 12. At this point, the rotation of media gear 12 and optical print head gear 18 has stopped. In order to traverse optical print head 20 back to its original position, as shown in FIG. 3, spindle motor 4 rotates in the direction of Arrow C. This will cause optical print head 20 to move away from the inner diameter of media 8 towards the outer diameter of media 8. It is to be understood that arm 24 could be attached to a spring (not shown). When gears 12 and 18 disengage, the OPH would be pulled by the spring to it's default position.

The present invention can be embodied in any computer-readable medium for use by or in connection with an instruction-execution system, apparatus or device such as a computer/processor based system, processor-containing system or other system that can fetch the instructions from the instruction-execution system, apparatus or device, and execute the instructions contained therein. In the context of this disclosure, a “computer-readable medium” can be any means that can store, communicate, propagate or transport a program for use by or in connection with the instruction-execution system, apparatus or device. The computer-readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc. It is to be understood that the computer-readable medium could even be paper or another suitable medium upon which the program is printed, as the program can be electronically captured, via, for instance, optical scanning of the paper or other medium, then compiled, interpreted or otherwise processed in a single manner, if necessary, and then stored in a computer memory.

Those skilled in the art will understand that various embodiment of the present invention can be implemented in hardware, software, firmware or combinations thereof. Separate embodiments of the present invention can be implemented using a combination of hardware and software or firmware that is stored in memory and executed by a suitable instruction-execution system. If implemented solely in hardware, as in an alternative embodiment, the present invention can be separately implemented with any or a combination of technologies which are well known in the art (for example, discrete-logic circuits, application-specific integrated circuits (ASICs), programmable-gate arrays (PGAs), field-programmable gate arrays (FPGAs), and/or other later developed technologies. In preferred embodiments, the present invention can be implemented in a combination of software and data executed and stored under the control of a computing device.

It will be well understood by one having ordinary skill in the art, after having become familiar with the teachings of the present invention, that software applications may be written in a number of programming languages now known or later developed.

Once given the above disclosure, many other features, modifications or improvements will become apparent to the skilled artisan. Such features, modifications or improvements are, therefore, considered to be a part of this invention, the scope of which is to be determined by the following claims.

What is claimed is:

1. An optical disk writing and printing apparatus comprising;
a motor operatively connected to an optical pickup unit and an optical print head such that the motor is engagingly connected to the optical pickup unit for assisting the optical pickup unit in writing data on one side of an optical disk and engagingly connected to the optical print head for assisting the optical print head in printing markings on another side of the optical disk.

2. The apparatus, as in claim 1, wherein the apparatus is further comprised of:
a spindle motor;
a media clamp operatively connected to the spindle motor and the optical disk;
a media hub operatively connected to the media clamp; and
a media gear operatively connected to the media hub.

3. The apparatus, as in claim 2, wherein the apparatus is further comprised of:
an optical print head gear;
an engagement/disengagement means operatively connected to the media gear and the optical print head gear; and
an optical print head arm operatively connected to the optical print head gear and the optical print head.

4. A method for writing and printing on an optical disk comprising:
utilizing a single motor to write data upon one side of an optical disk; and
utilizing the motor to print marks upon the other side of the optical disk.

5. The method, as in claim 4, wherein the writing data step is further comprised of:
disengaging an optical print head means from a media gear means;
rotating the optical disk and the media gear means; and
allowing an optical pickup unit to interact with the optical disk in order to write data upon the one side of the disk.

6. The method, as in claim 4, wherein the writing data step is further comprised of:
rotating the optical disk and the media gear means; and
allowing an optical pickup unit to interact with the optical disk in order to write data upon the one side of the disk.

7. The method, as in claim 5, wherein the media gear means is further comprised of:
a media clamp operatively connected to the single motor and the optical disk;
a media hub operatively connected to the media clamp; and
a media gear operatively connected to the media hub.

8. The method, as in claim 5, wherein the mark printing step is further comprised of:
engaging the optical print head means with the media gear means;
rotating the optical disk, the media gear means, and the optical print head means; and
allowing an optical print head means to interact with the optical disk in order to print marks upon the other side of the disk.

9. The method, as in claim 5, wherein the mark printing step is further comprised of:
rotating the optical disk, the media gear means, and the optical print head means; and
allowing an optical print head means to interact with the optical disk in order to print marks upon the other side of the disk.

10. The method, as in claim 5, wherein the optical print head means is further comprised of:
an optical print head gear;
an engagement/disengagement means operatively connected to the media gear means and the optical print head gear; and
an optical print head arm operatively connected to the optical print head gear and an optical print head.

11. The method, as in claim 6, wherein the optical print head means is further comprised of:
an optical print head gear;
an engagement/disengagement means operatively connected to the media gear means and the optical print head gear; and
an optical print head arm operatively connected to the optical print head gear and an optical print head.

12. A system for writing and printing on an optical disk comprising:
means for utilizing a single motor to write data upon one side of an optical disk; and
means for utilizing the motor to print marks upon the other side of the optical disk.

13. The system, as in claim 12, wherein the writing data means is further comprised of:
means for disengaging an optical print head means from a media gear means;
means for rotating the optical disk and the media gear means; and
means for allowing an optical pickup unit to interact with the optical disk in order to write data upon the one side of the disk.

14. The system, as in claim 12, wherein the writing data means is further comprised of:
means for rotating the optical disk and the media gear means; and
means for allowing an optical pickup unit to interact with the optical disk in order to write data upon the one side of the disk.

15. The system, as in claim 13, wherein the media gear means is further comprised of:
a media clamp operatively connected to the single motor and the optical disk;
a media hub operatively connected to the media clamp; and
a media gear operatively connected to the media hub.

16. The system method, as in claim 13, wherein the mark printing means is further comprised of:
means for engaging the optical print head means with the media gear means;
means for rotating the optical disk, the media gear means, and the optical print head means; and
means for allowing an optical print head means to interact with the optical disk in order to print marks upon the other side of the disk.

17. The system, as in claim 13, wherein the mark printing means is further comprised of:
means for rotating the optical disk, the media gear means, and the optical print head means; and
means for allowing an optical print head means to interact with the optical disk in order to print marks upon the other side of the disk.

18. The system, as in claim 13, wherein the optical print head means is further comprised of:
an optical print head gear;
an engagement/disengagement means operatively connected to the media gear means and the optical print head gear; and
an optical print head arm operatively connected to the optical print head gear and an optical print head.

19. The system, as in claim 14, wherein the optical print head means is further comprised of:
an optical print head gear;
an engagement/disengagement means operatively connected to the media gear means and the optical print head gear; and
an optical print head arm operatively connected to the optical print head gear and an optical print head.
means for utilizing a single motor to write data upon one side of an optical disk; and
means for utilizing the motor to print marks upon the other side of the optical disk.

20. A program storage medium readable by computer, tangibly embodying a program of instructions executable by the computer to perform method steps for a method for writing and printing on an optical disk comprising: utilizing a single motor to write data upon one side of an optical disk; and utilizing the motor to print marks upon the other side of the optical disk.

21. The method, as in claim 20, wherein the writing data step is further comprised of:
disengaging an optical print head means from a media gear means;
rotating the optical disk and the media gear means; and
allowing an optical pickup unit to interact with the optical disk in order to write data upon the one side of the disk.

22. The method, as in claim 20, wherein the writing data step is further comprised of:
rotating the optical disk and the media gear means; and
allowing an optical pickup unit to interact with the optical disk in order to write data upon the one side of the disk.

23. The method, as in claim 21, wherein the media gear means is further comprised of:
a media clamp operatively connected to the single motor and the optical disk;
a media hub operatively connected to the media clamp; and
a media gear operatively connected to the media hub.

24. The method, as in claim 21, wherein the mark printing step is further comprised of:
engaging the optical print head means with the media gear means;
rotating the optical disk, the media gear means, and the optical print head means; and
allowing an optical print head means to interact with the optical disk in order to print marks upon the other side of the disk.

25. The method, as in claim 21, wherein the mark printing step is further comprised of:
rotating the optical disk, the media gear means, and the optical print head means; and
allowing an optical print head means to interact with the optical disk in order to print marks upon the other side of the disk.

26. The method, as in claim 21, wherein the optical print head means is further comprised of:
an optical print head gear;
an engagement/disengagement means operatively connected to the media gear means and the optical print head gear; and
an optical print head arm operatively connected to the optical print head gear and an optical print head.

27. The method, as in claim 26, wherein the optical print head means is further comprised of:
an optical print head gear;
an engagement/disengagement means operatively connected to the media gear means and the optical print head gear; and
an optical print head arm operatively connected to the optical print head gear and an optical print head.
